(19) United States
(12) Patent Application Publication
(10) Pub. No.: US 2002/0040619 A1
(43) Pub. Date: Apr. 11, 2002

(54) Selectively hardened crankshaft and method for manufacturing the same

(76) Inventor: Chris R. Hatton, Peterborough (GB)

Correspondence Address: CATERPILLAR INC., 100 N.E. ADAMS STREET, PATENT DEPT., PEORIA, IL, 616296490

(21) Appl. No.: 09/971,896

(22) Filed: Oct. 5, 2001

(30) Foreign Application Priority Data
Oct. 6, 2000 (GB) 0024475.6

(51) Int. Cl. F16C 3/04

(52) U.S. Cl. 74/595

(57) ABSTRACT

A rotational component, such as a crankshaft for an internal combustion engine or the like, has fractional portions of the circumferential journal surfaces selectively hardened, as by induction hardening for example. The selectively hardened portions of the journal surfaces may include radially facing bearing surfaces, journal fillets, and other critical zones such as oil hole breakout zones and thrust face fillets. Selective hardening reduces component distortion and processing costs while providing the desired durability enhancement.

### TECHNICAL FIELD

This invention relates to selective hardening of rotational ferrous components. The invention may be applied to a variety of components, but will be particularly described herein with reference to crankshafts for internal combustion engines.

### BACKGROUND

It is common practice to improve the wear and fatigue characteristics of crankshafts by induction hardening, that is a process in which an induction coil is used to produce localised heating, which is followed by quenching to produce a hardened surface. Typically, the crankshaft is of steel and the hardening process results in conversion to martensitic phase. In prior art processes for the induction hardening of crankshafts (see for example U.S. Pat. No. 6,013,904 to Storm et al.), the entire circumference of each journal is hardened. This is normally done by positioning an induction coil in close proximity to the journal and then causing relative rotation between the induction coil and the journal while heating is carried out, although processes without relative rotation are known.

The conventional induction hardening process has a number of drawbacks. The thermal effects and the phase change to martensitic form induce component distortion such as bend, twist and axial growth. There is a significant energy consumption. Where a crankshaft is rotated during induction heating to heat the entire circumference, relatively complex apparatus is required.

A prior art process is also known for hardening only a fractional portion of a circumferential fillet or radius joining a crankshaft journal to a web portion of the crankshaft (see for example U.S. Pat. No. 3,824,659 to Sommer). However, the process illustrated in the Sommer '659 patent provides no additional wear resistance to the bearing surfaces of the journals themselves.

This invention is directed to overcoming one or more of the problems identified above.

### SUMMARY OF THE INVENTION

In one aspect of this invention, a crankshaft comprises at least one main journal having a longitudinal axis and at least one rod journal having a longitudinal axis spaced from the main journal longitudinal axis. Each journal has a radially facing, circumferential bearing surface, and a circumferentially extending fractional portion of the radially facing, circumferential bearing surface of at least one of the journals is hardened. The remaining fractional portion of the radially facing, circumferential bearing surface of such journal is substantially unhardened.

In another aspect of this invention, a method of manufacturing a crankshaft is disclosed. The crankshaft comprises at least one main journal having a longitudinal axis and at least one rod journal having a longitudinal axis spaced from the main journal axis. Each of the journals has a radially facing, circumferential bearing surface. The method comprises the steps of hardening a circumferentially extending, fractional portion of the radially facing, circumferential bearing surface of at least one of the journals and leaving the remaining fractional portion of the circumferential surface of such journal substantially unhardened.

Other features and aspects of this invention will become apparent from the following description and the accompanying drawings.

### BRIEF DESCRIPTION OF THE DRAWINGS

FIG. 1 is a fragmentary side view of part of a crankshaft for an internal combustion engine in accordance with this invention.

FIG. 2 is a cross-sectional view of the crankshaft show in FIG. 1 taken along line 2-2 of FIG. 1.

FIG. 3 is a cross-sectional view of the crankshaft taken along line 3-3 of FIG. 2.

### DETAILED DESCRIPTION

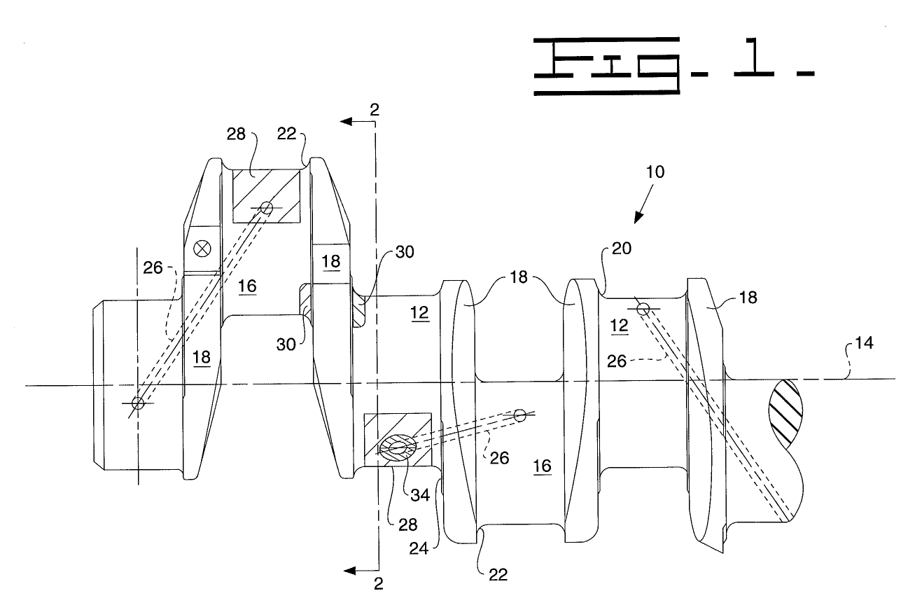

FIG. 1 shows part of a ferrous rotational component, in this embodiment a steel crankshaft 10. The crankshaft 10 includes main journals 12 aligned on the crankshaft axis 14. Rod journals 16 are offset from the crankshaft axis 14 by webs 18. The main journals 12 are provided with curved main journal fillets 20 at the transitions to the adjacent webs 18, and the rod journals are likewise provided with curved rod journal fillets 22. Portions of the fillets 20 and 22 are extended as best seen in FIG. 3 to form thrust face fillets 24. The crankshaft 10 is formed with drilled oil holes 26 interconnecting each main journal 12 with an adjacent rod journal 16. In accordance with this invention, the crankshaft 10 is hardened in selected areas of its rotational surfaces by induction hardening. Rotational surfaces are surfaces generated by rotation of a line about an axis. Such rotational surfaces may also be referred to as circumferential or peripheral surfaces.

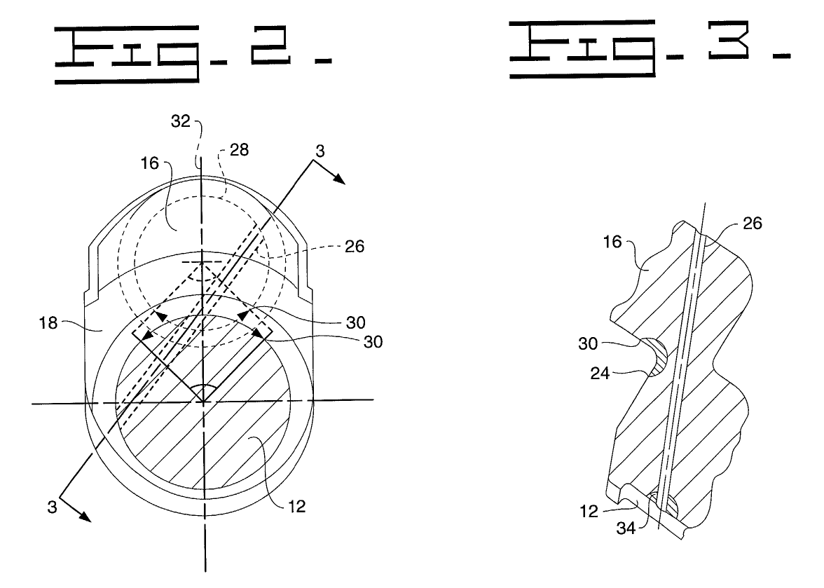

Induction hardening is applied to fractional, arcuate portions 30 of the circumference of the main journal fillets 20 and the rod journal fillets 22. These fractional, arcuate portions 30 correspond to fatigue zones in which there is the potential for significant fatigue. The circumferential extent of these arcuate portions may be predicted from stress analysis and/or design experience, or could be determined empirically by running a test engine followed by examination. Typically each of the arcuate hardened portions 30 will extend over an arc of between 45 degrees and 150 degrees centered on the centerline 32 of the overlap portion between the main journal 12 and the rod journal 16, as best seen in FIG. 2.

Similarly each of the main journals 12 and rod journals 16 is hardened along a circumferentially extending, radially facing fractional portion of the circumferential bearing surface thereof, namely in a wear zone 28. Only two wear zones 28 are shown in FIG. 1 for ease of illustration, but it will be understood that similar zones are formed on the other journals 12 and 16. Each wear zone 28 is hardened over an fractional, arcuate portion of the circumference of the respective journal 12 or 16 corresponding to the wear zone in which there is the potential for significant wear. It is also desirable that the transition between the hardened wear zone 28 and the remainder of the surface of the journal 12 or 16 be located in an area of low stress. Again, the optimum circumferential arc length of the arcuate portion can be determined empirically, but typically each wear zone 28 will extend over an arc of somewhat less than 180 degrees, although this will vary according to the application.

It is to be understood that on a particular crankshaft it may be desirable to provide localised hardening only to the fillets 20, 22 and not to the journals 12, 16.

In addition, localised induction hardening may be applied to selected critical features of the crankshaft 10 that are subject to high stress. In the embodiment shown, hardening is applied to oil hole breakout zones (that is, a zone where an oil hole 26 intersects the surface of the crankshaft 10) such as 34, and to the thrust face fillets 24. Other critical features (not shown) which could be hardened include balance weight fixing points, timing wheel fixing points, and drillings.

The hardening is carried out by clamping induction coils to the selected portions of the crankshaft, or otherwise fixedly positioning the coils relative to the crankshaft. There is no need for relative rotation between the induction coils and the crankshaft. Power is then applied to produce localised heating by induction, followed by quenching. The processing powers, times and temperatures and suitable forms of induction coils and power supplies will be apparent to those in the art from conventional induction hardening processes. While selective induction hardening is preferred, those skilled in the art will recognize that other hardening processes may be used to selectively harden only portions of the circumferential surfaces of the crankshaft 10.

### INDUSTRIAL APPLICABILITY

The invention has industrial applicability in the production of crankshafts of steel, ductile iron and other ferrous metals and other rotational components of ferrous metals, which require hardening over a fractional portion of a of a circumferential surface thereof. The process according to the invention can produce components with less distortion, in particular bend, twist and axial growth, and with reduced cycle time, energy consumption and capital equipment cost. Consequently, improved fatigue strength and wear resistance can be achieved in desired regions of the crankshaft 10 with lower costs and lower cycle times when compared to conventional hardened crankshafts in which the entire circumferential surface of the journals are hardened.

What is claimed is:

1. A crankshaft, comprising:
at least one main journal, said main journal having a longitudinal axis;
at least one rod journal having a longitudinal axis spaced from the main journal longitudinal axis;
said journals each having a radially facing, circumferential bearing surface;
wherein a circumferentially extending fractional portion of the radially facing, circumferential bearing surface of at least one of said journals is hardened and the remaining fractional portion of the radially facing, circumferential bearing surface of said at least one of said journals is substantially unhardened.

2. The crankshaft of claim 1 including a circumferential fillet joining said at least one journal to a web portion of said crankshaft, and wherein a circumferentially extending, fractional portion of said fillet is hardened and the remaining fractional portion of said fillet is substantially unhardened.

3. The crankshaft of claim 2 wherein said hardened radially facing portion of said radially facing, circumferential bearing surface and the hardened fractional portion of said fillet are angularly separated.

4. The crankshaft of claim 1 wherein said crankshaft includes localized high stress areas, and wherein a fractional portion of a surface of said crankshaft around said localized high stress areas is hardened.

5. The crankshaft claim 4 wherein said localized high stress areas are selected from the group consisting of oil hole breakout zones, thrust face fillets, fixing point for balance weights, fixing points for timing wheels, and drillings.

6. The crankshaft of claim 1 wherein said hardened fractional portion of the radially facing, circumferential bearing surface has a circumferential arc length less than 180 degrees.

7. The crankshaft of claim 1 wherein a fractional portion of the radially facing, circumferential bearing surface of each of said journals is hardened and the remaining fractional portion of the circumferential surface of each of said journals is substantially unhardened.

8. The crankshaft of claim 1 wherein said hardened fractional portion of said radially facing, circumferential bearing surface is hardened by applying heat only to said fractional portion of said circumferential surface by way of electrical induction and thereafter quenching said heated surface.

9. A method of manufacturing a crankshaft, said crankshaft comprising at least one main journal having a longitudinal axis and at least one rod journal having a longitudinal axis spaced from said main journal axis, each of said journals having a radially facing, circumferential bearing surface, said method comprising the steps of:
hardening a circumferentially extending, fractional portion of the radially facing, circumferential bearing surface of at least one of said journals; and
leaving the remaining fractional portion of the circumferential surface of said at least one of said journals substantially unhardened.

10. The method of claim 9 wherein said crankshaft includes a circumferential fillet joining said at least one journal to a web portion of said crankshaft, and wherein said method includes the steps of hardening a fractional portion of said fillet and leaving the remaining fractional portion of said fillet substantially unhardened.

11. The method of claim 10 wherein said hardened fractional portion of said circumferential bearing surface and the hardened fractional portion of said fillet are angularly separated.

12. The method of claim 9 wherein said crankshaft includes localized high stress areas, and wherein said method includes the step of hardening a fractional portion of a surface of said crankshaft around said localized high stress areas.

13. The method claim 12 wherein said localized high stress areas are selected from the group consisting of oil hole breakout zones, thrust face fillets, fixing point for balance weights, fixing points for timing wheels, and drillings.

14. The method of claim 9 wherein said hardening step includes applying heat only to said fractional portion of said circumferential bearing surface by way of electrical induction and thereafter quenching said heated surface.

15. The method of claim 9 wherein the hardened fractional portion of the radially facing, circumferential bearing surface has a circumferential arc length less than 180 degrees.
